(19) United States
(12) Patent Application Publication
(10) Pub. No.: US 2008/0283319 A1
(43) Pub. Date: Nov. 20, 2008

(54) Wind energy extender

(76) Inventor: Cleo Camille Putnam, Arlington, TX (US)

Correspondence Address: MRS. CLEO CAMILLE PUTNAM, 908 CURTIS DR., ARLINGTON, TX, 76012, US

(21) Appl. No.: 11/803,885

(22) Filed: May 16, 2007

(51) Int. Cl. B60K 6/405; F03D 9/02

(52) U.S. Cl. 180/165; 290/50; 290/55; 903/952

(57) ABSTRACT

Self-generated wind due to the forward progress of a vehicle is captured in an air flow chamber housing a wind energy system, which has a horizontal wind turbine with multiple blades moving in a clockwise direction. The air flow chamber is positioned in an optimal manner to harness the air flow and is essential to producing ecologically desirable wind energy by using a generator to send an AC electric current to be stored in the battery of an electric or hybrid vehicle in order to extend its travel distance.

Wind Energy Extender is the title of this invention, which is a new and useful improvement to the utility process of producing electricity from wind energy. There is not any cross reference to related pending applications. This is not a federally sponsored research project. No computer sequence listing is included. The field of this invention is producing electricity from wind energy in the transportation industry.

### BACKGROUND

The aerodynamic design of a vehicle like the automobile has been desired and studied in order to make the automobile perform at the highest racing speed and efficiency. The slope of the top and tailfin have been designed to prevent drag on the forward progress of the vehicle. The force of the air flow caused by driving was considered a nuisance, since it deterred the speed of the vehicle.

Every child has held his or her hand out of a car window and felt the air pushing the hand first up and then down in a circular movement, but no one has brought about the capturing or harnessing of this air flow to extend the fuel supply to continue the vehicle travel distance.

A design of a car, a bus, a truck, a pickup, or other vehicle to use the free and readily available air flow surrounding the vehicle has surprisingly not been suggested, utilized or brought to culmination. This air flow is the wind source, which is self-generated by the mere act of moving forward. This invention is a new and useful improvement to wind turbine system. Wind turbine systems have been used to store energy in batteries for many years on farms and in homes. Many choices of numbers of blades and variations of alternators and generators are commercially available.

The preferred embodiment of this improvement to the process of current creation is in an electric or hybrid automobile. At the present time, the problem with the electric automobile is that it tends to be a small short distance vehicle. It cannot charge its battery enough to fulfill the requirement of a large automobile's expected daily drive. It is combined with the gasoline engine or other source of fuel in order to be commercially viable in today's transportation world.

### BRIEF SUMMARY

The exact nature of this new and useful improvement to a wind energy system will create a new application or usage for wind energy. Wind energy has not been combined with other fuel sources in the transportation industry.

Although the improvement gives a simple and ecologically green fuel source, it has not been tapped in the past. The air flow surrounding a vehicle, which is moving forward, is used for the first time to produce AC electric current with a generator. The generated current is then stored in a battery to be used by a hybrid or electric vehicle. It must be clear that the electric charge to the battery is not intended to be the only fuel or energy source.

The operation of the air flow chamber harnesses wind power in order to turn a wind turbine, which is connected to a generator to send AC electrical current to the commercially available hybrid vehicle battery storage, which is likely to be a rechargeable Nickel-Metal Hydride Battery. The purpose of this new and useful improvement to a wind energy system is to extend the energy available to the vehicle.

### BRIEF DESCRIPTION OF THE SEVERAL VIEWS OF THE DRAWINGS

The drawings of the Wind Energy Extender display the operation of harnessing of the self-generated air flow to produce the AC electric current by showing the outside and inside of the Air Flow Chamber involved in the process of the improvement to the wind energy production to be used to extend the energy source for a vehicle.

FIG. 1 is a right frontal view of the Wind Energy Extender installed in its best embodiment. The front left Air Flow Intake Vent of the Air Flow Chamber is shown.

FIG. 2 is a left rear view of the Wind Energy Extender installed in its best embodiment. The rear Air Flow Outtake Vent of the Air Flow Chamber is shown.

FIG. 3 is a top view of horizontal wind turbines of the Wind Energy System as they appear installed on the roof of the vehicle, which is the bottom of the Air Flow Chamber. The rectangular box is not intended to be a border of FIG. 3. The perimeter horizontal lines of FIG. 3 show the length of the roof of the vehicle from front on the left to the rear on the right. The perimeter vertical view of FIG. 3 shows the sides of the roof of the vehicle.

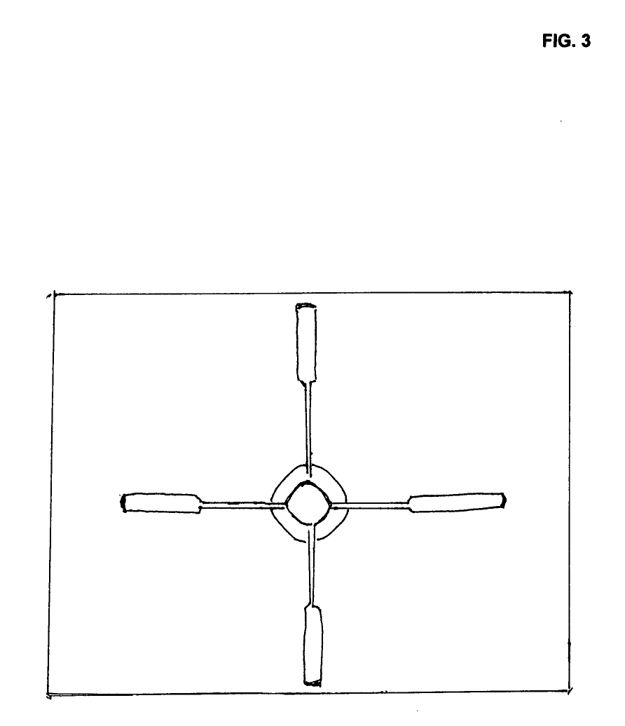

FIG. 4 is a cross section of the Air Flow Chamber displaying wind turbine assembly from the horizontal view from the right side the roof of the vehicle.

### DETAILED DESCRIPTION

The useful advantages of using the air flow created by the forward movement of a vehicle is graced with the absence of pollution causing carbons. This wind energy is available and not costly. This air flow cannot be harnessed without the Air Flow Chamber. This custom-made Chamber, which is constructed of fiberglass, houses the wind turbine, which may vary as to composition material. The wind turbines can be made of wood, metal or fiberglass. The top of the Air Flow Chamber has a surface that can be painted to match the exterior of the vehicle.

Electric vehicles are presently useful to travel a short distance on a night's charge. The Air Flow Chamber improvement to any number of possible wind energy systems for producing DC or AC electrical current can enable the hybrid or electric vehicle to extend its travel distance, since it continually recharges the battery as electric power is used.

It needs to be made clear that this improvement is not intended to be the sole energy source for any vehicle, but instead an extender of energy source. The best installation of this useful improvement is a hybrid vehicle, which combines gasoline and electric energy sources. These vehicles are presently available commercially.

Although not the only possible form of the wind energy system, the best embodiment is a propeller type wind turbine system already in existence. An example of one of these wind turbine systems is U.S. Pat. No. 6,921,243 Jean Marc Canini, et al.

The new and useful improvement to the wind energy system is composed of an Air Flow Chamber formed by the bolted attachment of a piece of cupped fiberglass to the reinforced metal roof of a transportation vehicle making the roof the bottom of the Air Flow Chamber. The generator is welded to the roof. Although the Air Flow Chamber could conceivably be placed at the bottom or sides of the vehicle, the roof placement is the best positioning. The depth of the chamber is 8″. The Air Flow Chamber needs to be at least 38″ in length and width. The maximum size depends on the width and length of the vehicle. The requirement for the size of the chamber is to accommodate a range from 16″ to 20″ length for the blades of the wind turbine.

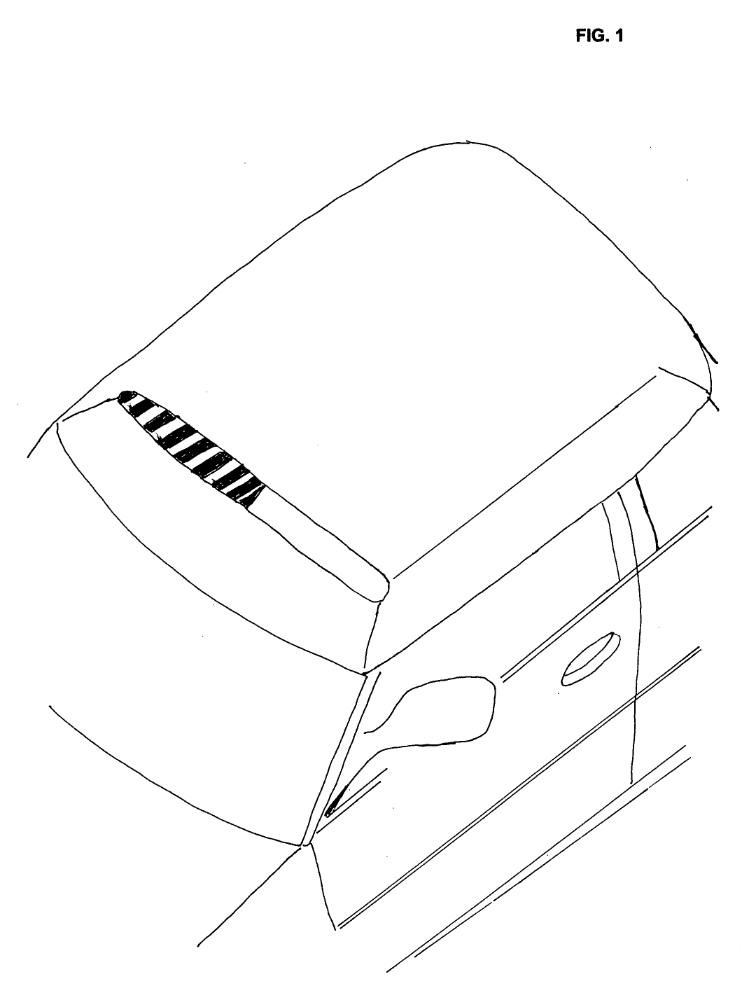

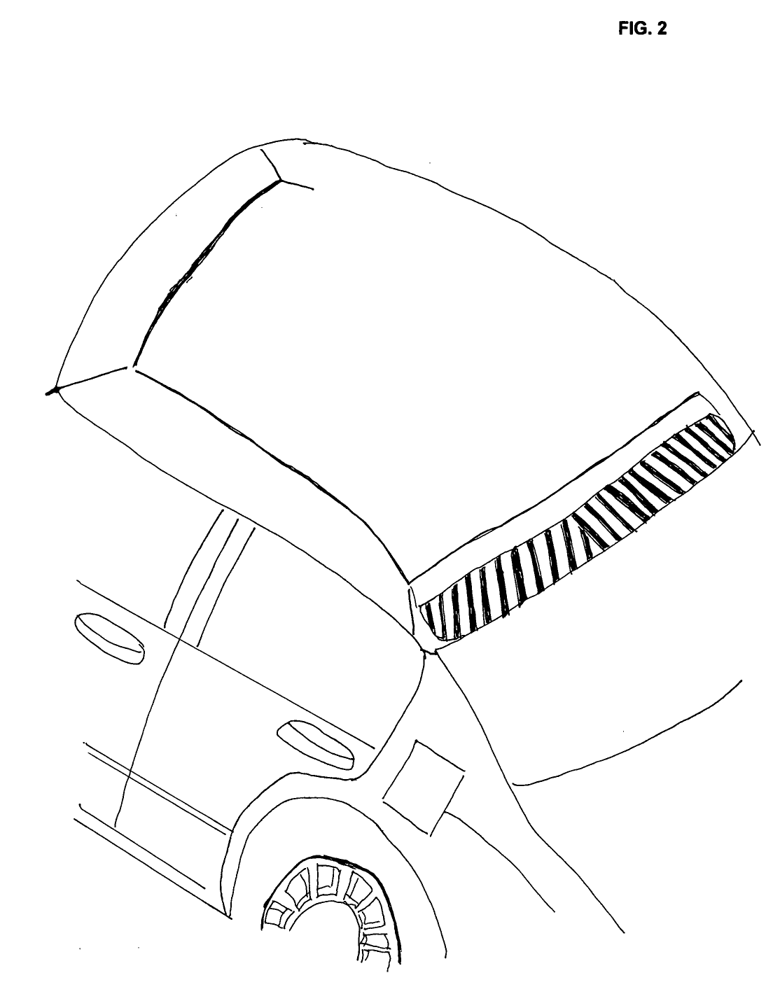

The left front of the Chamber has a vent, which contains the Air Flow Intake Vent. The right front of the Chamber is closed. The left front of the vent is open and is the Air Flow Intake Vent shown in FIG. 1. The air flow is forced into the Air Flow Intake Vent by the forward movement of the vehicle. The air flow moves the propeller style blades in a clockwise direction as the car accelerates. The air flow then exits from the Air Flow Chamber through the rear Air Flow Outtake Vent shown in FIG. 2, which is slotted open across the entire bottom of the rear. The wind energy assembly is comprised of a hub with four horizontal wind turbine blades made of fiberglass. The two sets of wind turbine blades of 2″ width are slanted at a 75% angle. The smaller portion of the blades are placed opposite of each other on the hub. The combined measurement of the blades and hub is at least 36″.

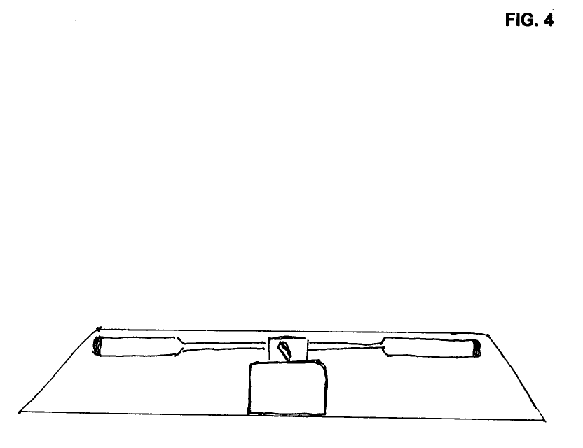

The generator is directly fixed to the bottom of the propeller style windmill as shown in the cross section view in FIG. 4. The best embodiment of the high performance electric generator is comprised of a stator and a rotor both in the shape of a disk carrying facing electromagnetic members to produce the AC electric current. The electronic control unit of the generator supplies a constant frequency and optimizes operation. The generator produces the AC current, which is sent down wires that travel from the generator through a drilled hole in the roof of the vehicle or bottom of the Air Flow Chamber down to a rechargeable Nickel-Metal Hydride Battery, which is presently commercially available to hybrid vehicles. The location of the battery is expected to be in the rear of the vehicle, but may vary.

1. The self-created air flow surrounding a moving vehicle is captured in an air flow chamber housing a wind energy system and results in extending the electrical stored energy in a battery to be used by an electric or hybrid vehicle for transportation.
